(19) United States
(12) Patent Application Publication
(10) Pub. No.: US 2023/0234256 A1
(43) Pub. Date: Jul. 27, 2023

(54) PUNCHER CAPABLE OF FAST AND ACCURATE POSITIONING

(71) Applicants: DUNHUA YANG, Shantou (CN); Douglas Miles Cushing, Lakewood, OH (US)

(72) Inventors: DUNHUA YANG, Shantou (CN); Douglas Miles Cushing, Lakewood, OH (US)

(21) Appl. No.: 18/101,582

(22) Filed: Jan. 26, 2023

(30) Foreign Application Priority Data
Jan. 26, 2022 (CN) 2022202079751

(51) Int. Cl. B26F 1/40

(52) U.S. Cl. CPC B26F 1/40

(57) ABSTRACT

A puncher capable of fast and accurate positioning is provided, which includes a cutter unit, a pressing plate, a bottom seat and magnetic attracting units. The cutter unit, a pressing plate and the bottom seat are each provided with magnetic attracting units. The cutter unit is attracted on the bottom seat, and the pressing plate is attracted on the bottom seat, for clamping the object to be punched between the pressing plate and the bottom seat. The present application has the beneficial effects that the pressing plate is arranged between the cutter unit and the bottom seat, and the magnetic attracting units are arranged on the cutter unit, the pressing plate and the bottom seat, such that the object to be punched can be quickly clamped for being accurately drilled, and the cutter unit, the pressing plate and the bottom seat can be easily assembled and disassembled.

### FIELD

The present application relates to a puncher, more specifically to a puncher capable of fast and accurate positioning.

### BACKGROUND

The conventional paper punching machine mainly uses a punching machine and a ruler in cooperation to position and punch the paper. In this structure, it is necessary to determine the position of paper punching through the ruler, then place the side of the paper on the punching machine and the ruler for positioning, and finally press holes with the same spacing in the paper through the punching machine. However, when the paper is placed on the punching machine without being held by a positioning structure, it is apt to cause the paper to shift when being punched, and further cause the punching position to be apt to be inaccurate. Moreover, due to the large volume and fixed structure of the traditional punching machine, it is not easy to disassemble and assemble, and it also makes it inconvenient for users to carry.

### SUMMARY

An aspect of the present application is to provide a puncher capable of fast and accurate positioning. The puncher capable of fast and accurate positioning can effectively improve the accuracy of paper punching by arranging a pressing plate between a cutter unit and a bottom seat. The technical scheme adopted is as follows.

A puncher capable of rapid and accurate positioning, includes a cutter unit, a pressing plate, and a bottom seat from top to bottom. The cutter unit includes a ejector rod for drilling, a top cover, a base, and a number of first springs. The top cover is installed on the base to be movable up and down, one end of the ejector rod is fixed on an inner side of the top cover, another end of the ejector rod is a punching end, which faces towards the base, and moreover, the base is provided with a guide hole for the ejector rod to pass through. The first springs are arranged between the top cover and the base, and the first springs act on the top cover.

The pressing plate is arranged between the base and the bottom seat, and the pressing plate is provided with at least one first avoidance hole for the ejector rod to pass through.

The bottom seat is configured to bear an object to be punched, and is provided with at least one second avoidance hole for the ejector rod to pass through, the at least one second avoidance hole and the at least one first avoidance hole are arranged in one-to-one correspondence.

The base is provided with a number of first magnetic attracting units, and the pressing plate is provided with a number of second magnetic attracting units, the bottom seat is provided with a number of third magnetic attracting units and a number of fourth magnetic attracting units, the third magnetic attracting units are magnetically attracted to the first magnetic attracting units to allow the base to be attracted on the bottom seat, and the fourth magnetic attracting units are magnetically attracted to the first magnetic attracting units and the second magnetic attracting units respectively to allow the base and the pressing plate to be attracted on the bottom seat, for clamping the object to be punched between the pressing plate and the bottom seat.

With the above design, the top cover is pressed downward to drive the ejector rod to move downward synchronously. The ejector rod passes through the first avoidance hole and the second avoidance hole successively to implement the punching operation at one position of the paper. When the external force disappears, the top cover receives a restoring force of the first spring to move upward and be reset, and drive the ejector rod to move upward and be reset synchronously. At this time, the punching position of the object to be punched can be changed. Since the pressing plate is arranged between the cutter unit and the bottom seat, the accuracy of paper punching can be effectively improved. Moreover, the base and the pressing plate are each attracted on the bottom seat. When the position of the base changes, the position of the pressing plate will not shift, so that the position of the paper will not shift, thus ensuring the accuracy of paper punching. The magnetic attracting units are arranged on the base, the pressing plate and the bottom seat, so that the paper can be quickly clamped for being accurate punched, and the base, the pressing plate and the bottom seat can be easily and conveniently assembled and disassembled.

Further, the cutter unit further includes a locking device, and the locking device includes a locking member, a first magnet, a second spring and a first stopper. The locking member is connected to the base by a pivot, the first magnet is arranged at the locking member, the second spring acts on the locking member, and the first magnet and the second spring are distributed on radial opposite sides of the pivot respectively. The second spring acts on the locking member. A second magnet is arranged on the bottom seat, and the second magnet and the first magnet are magnetically attractive/repulsive to each other. The first stopper is arranged on the inner side of the top cover. When the first magnet is magnetically attracted to the second magnet, and a torque direction of a magnetic force applied to the locking member is consistent with a torque direction of a preload of the second spring applied to the locking member. In this case, the locking member is set in a locked state, and a top end of the locking member can contact with a bottom end of the first stopper to thereby restricting the top cover from moving downward. When the first magnet and the second magnet are magnetically repulsive, the torque direction of the magnetic force applied to the locking member is opposite to the torque direction of the preload of the second spring applied to the locking member, and the magnetic repulsion force applied to the locking member can overcome part of the preload of the second spring, and in this case, the locking member is set to an open state. The locking member moves around the pivot towards a direction away from the second magnet, and further the top end of the locking member is offset from the first stopper, so that the top cover is movable downward.

With such an arrangement, by additionally providing the locking device, it can prevent the user from being injured or the object from being damaged due to misoperation.

### BRIEF DESCRIPTION OF THE DRAWINGS

FIG. 1 is a schematic diagram of a puncher according to the present application in an assembled state;

FIG. 2 is a first schematic diagram of the puncher according to the present application in an exploded state;

FIG. 3 is a second schematic diagram of the puncher according to the present application in an exploded state;

FIG. 4 is a schematic structural diagram of some components of a cutter unit according to the present application;

FIG. 5 is a schematic structural diagram of a locking device according to the present application;

FIG. 6 is a structural sectional view of a cutter unit according to the present application in a locked state;

FIG. 7 is a structural sectional view of the cutter unit according to the present application in an open state;

FIG. 8 is a schematic structural diagram of a fixing plate on a base according to the present application in a disassembled state;

FIG. 9 is a reference diagram of a top cover and other building block splicers spliced with each other according to the present application in use;

FIG. 10 is a reference diagram of an object to be punched after being punched.

### DETAILED DESCRIPTION OF EMBODIMENTS

The present application is further described in conjunction with the attached drawings.

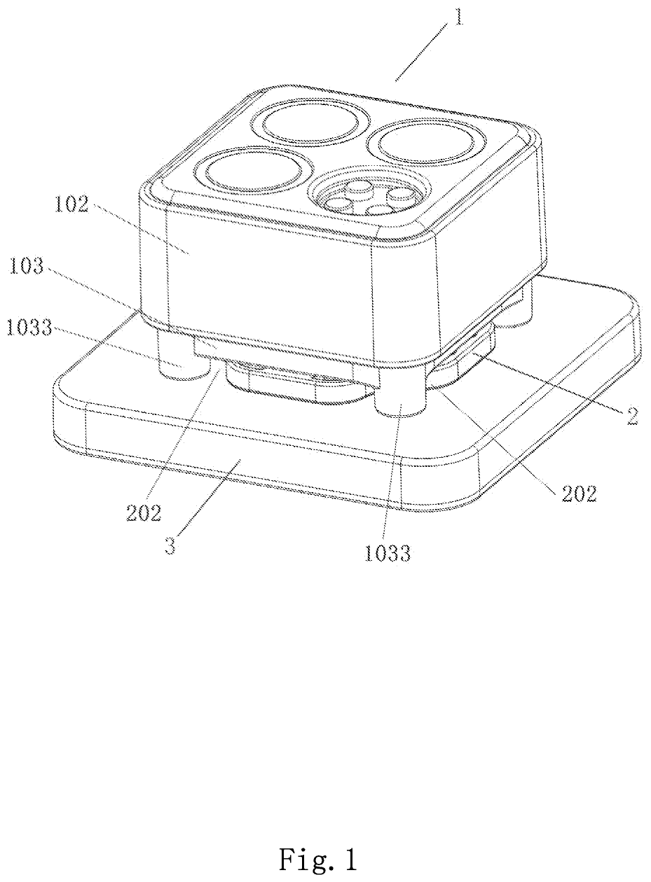

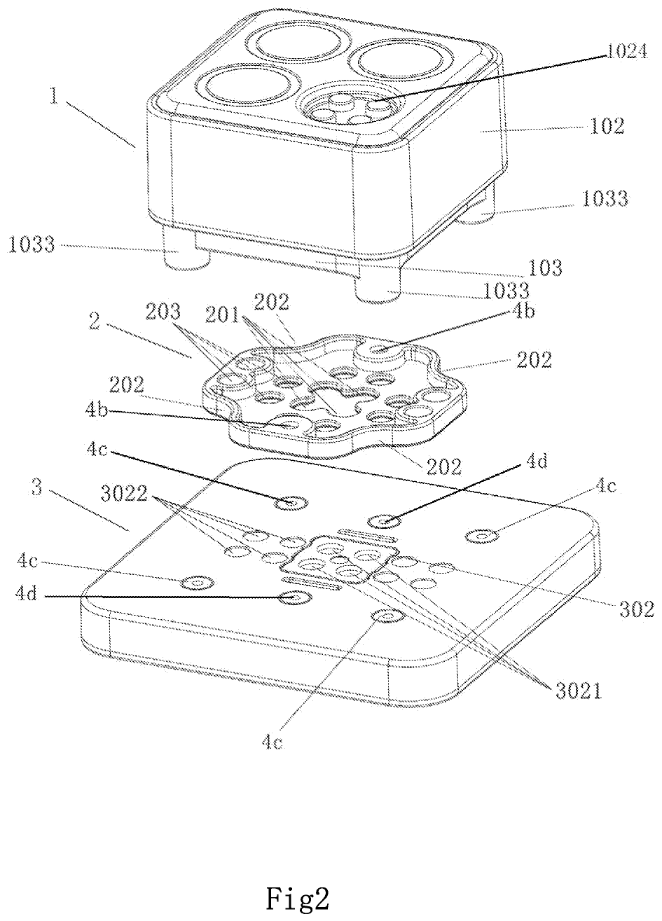

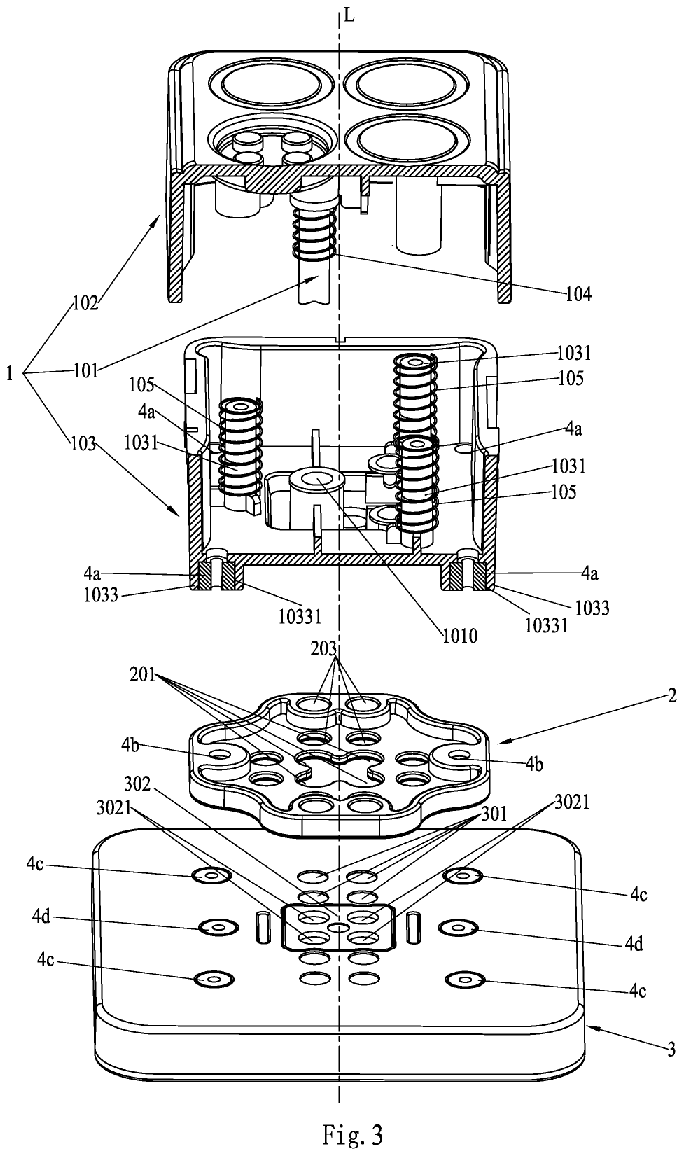

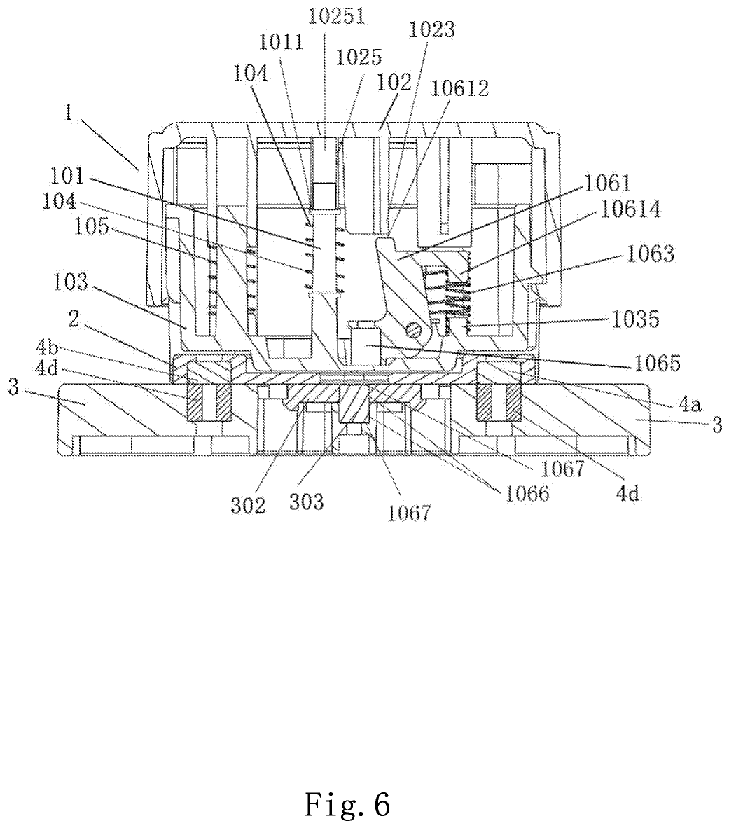

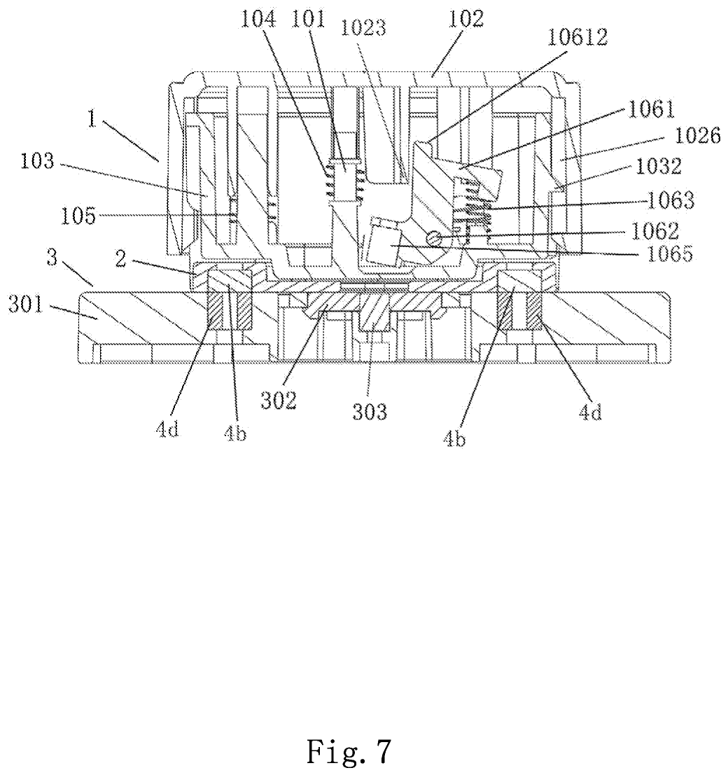

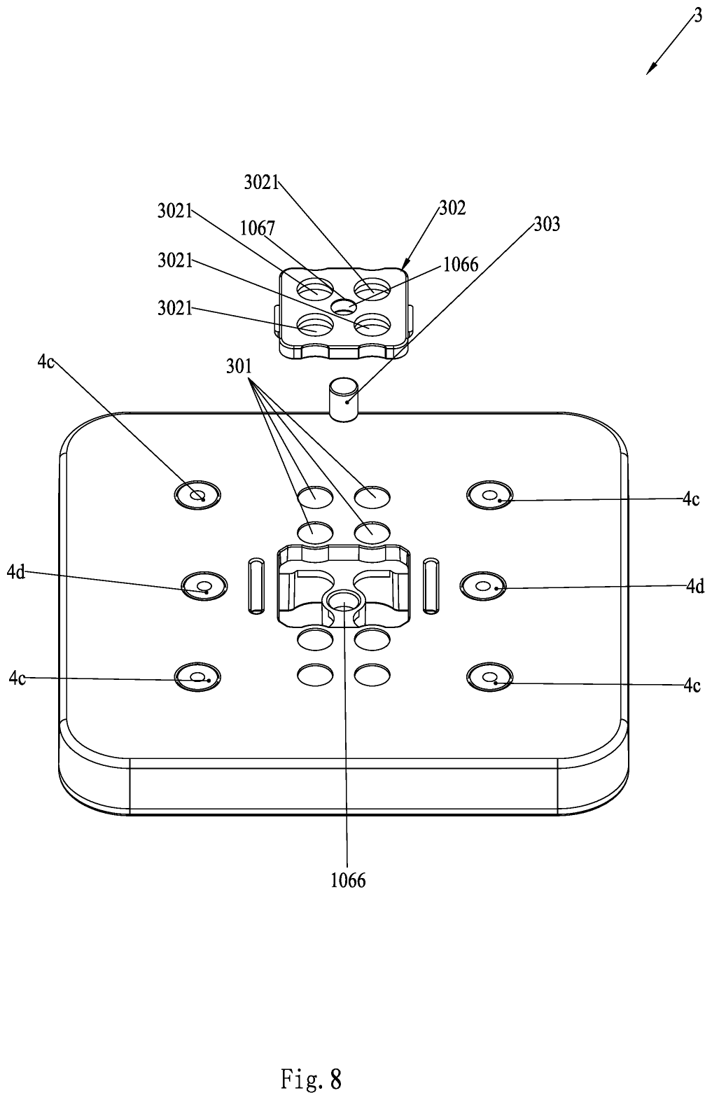

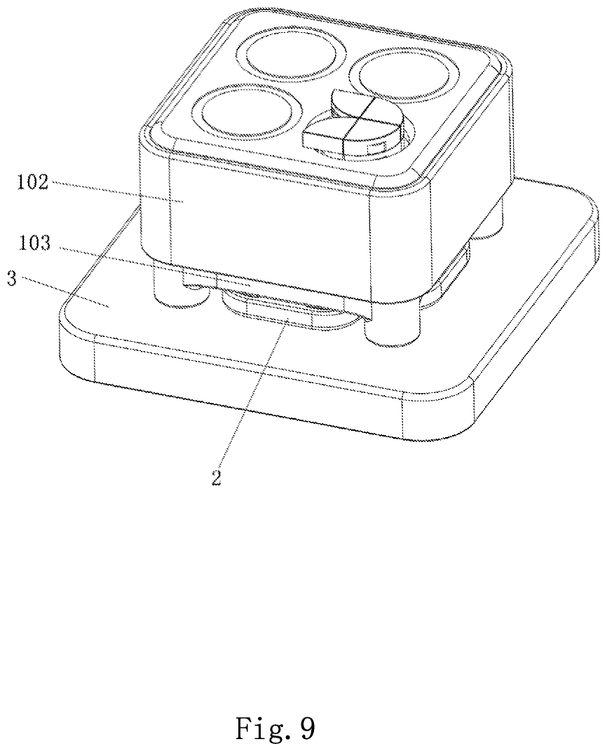

Reference is made to FIG. 1 to FIG. 10, a puncher capable of rapid and accurate positioning is provided, which includes a cutter unit 1, a pressing plate 2, and a bottom seat 3 from top to bottom. Specifically, the cutter unit 1 includes a ejector rod 101 for drilling, a top cover 102, a base 103, a locking device, a number of first springs 105, and a third spring 104. The top cover 102 is installed on the base 103 to be movable up and down. An inner side of the top cover 102 is provided with at least one position-limiting groove 1026 extending in a vertical direction, and an outer side of the base 103 is provided with at least one engaging block 1032 corresponding in position to the at least one position-limiting groove 1026. The engaging block 1032 is fitted with the position-limiting groove 1026 to prevent the top cover 102 from separating from the base 103 when it moves upward. Please refer to FIG. 3, FIG. 6 and FIG. 7, the inner side of the top cover 102 is at least provided with a second stopper 1025, the second stopper 1025 has a slot 10251, one end of the ejector rod 101 is disposed in the slot 10251, and the end of the ejector rod 101 is provided with a ring-shaped flange 1011, the third spring 104 is sleeved on the ejector rod 101, and two ends of the third spring 104 are respectively against inner sides of the ring-shaped flange 1011 and the base 103. A preload (elastic restoring force) applied to the ejector rod 101 by the third spring 104 allows the ring-shaped flange 1011 to always abut against and contact with a bottom end of the second stopper 1025, and further allows one end of the ejector rod 101 to be fixed on an inner side end face of the top cover 102. Another end of the ejector rod 101 is a punching end, which faces towards the base 103, and moreover, the base 103 is provided with a guide hole 1010 for the ejector rod 101 to pass through. An inner side end face of the base 103 is provided with a number of upwardly extending positioning columns 1031. The first springs 105 are sleeved on the positioning columns 1031 respectively and act on the top cover 102. Please refer to FIG. 1 and FIG. 2, corners at the bottom of the base 103 are each provided with a downwardly extending protruding column 1033. The protruding column 1033 is provided with a mounting hole 10331, and the first magnetic attracting unit 4a is provided in each of the mounting holes 10331.

Please refer to FIGS. 1 to 3, the pressing plate 2 is arranged between the base 103 and the bottom seat 3. The pressing plate 2 is provided with an avoidance part 202 at a position corresponding to each of the protruding columns 1033. The pressing plate 2 is provided with a number of second magnetic attracting units 4b, and the pressing plate 2 is provided with at least one first avoidance hole 201 for the ejector rod 101 to pass through.

Please refer to FIG. 1 to FIG. 3 and FIG. 6 to FIG. 8, the bottom seat 3 is configured to carry an object 5 (paper) to be punched. A removable/mountable fixing plate 302 and a removable/mountable second magnet 303 are arranged on the bottom seat 3. The fixing plate 302 is configured to position the second magnet 303 on the bottom seat 3. Specifically, please refer to FIG. 6 to FIG. 8, the fixing plate 302 and the bottom seat 3 are each provided with a fixing hole 1066 for disposing the second magnet 303 therein, a retaining edge 1067 is convexly provided on a wall of each of the fixing holes 1066, and the second magnet 303 is limited between the two retaining edges 1067, so that the second magnet 303 is positioned on the bottom seat 3. The fixing plate 302 is provided with at least one second avoidance hole 3021 for the ejector rod 101 to pass through. The at least one second avoidance hole 3021 and the at least one first avoidance hole 201 are arranged in one-to-one correspondence. Apparently, the at least one first avoidance hole 201 can be independent from each other or in communication with each other, and the at least one second avoidance hole 3021 can be independent from each other or in communication with each other. Reference is made to FIG. 3, the bottom seat 3 is provided with a number of third magnetic attracting units 4c and a number of fourth magnetic attracting units 4d. The third magnetic attracting units 4c are magnetically attracted to the first magnetic attracting units 4a to allow the base 103 to be attracted on the bottom seat 3, and the fourth magnetic attracting units 4d are magnetically attracted to the second magnetic attracting units 4b to allow the pressing plate 2 to be attracted on the bottom seat 3, for clamping the paper 5 between the pressing plate 2 and the bottom seat 3.

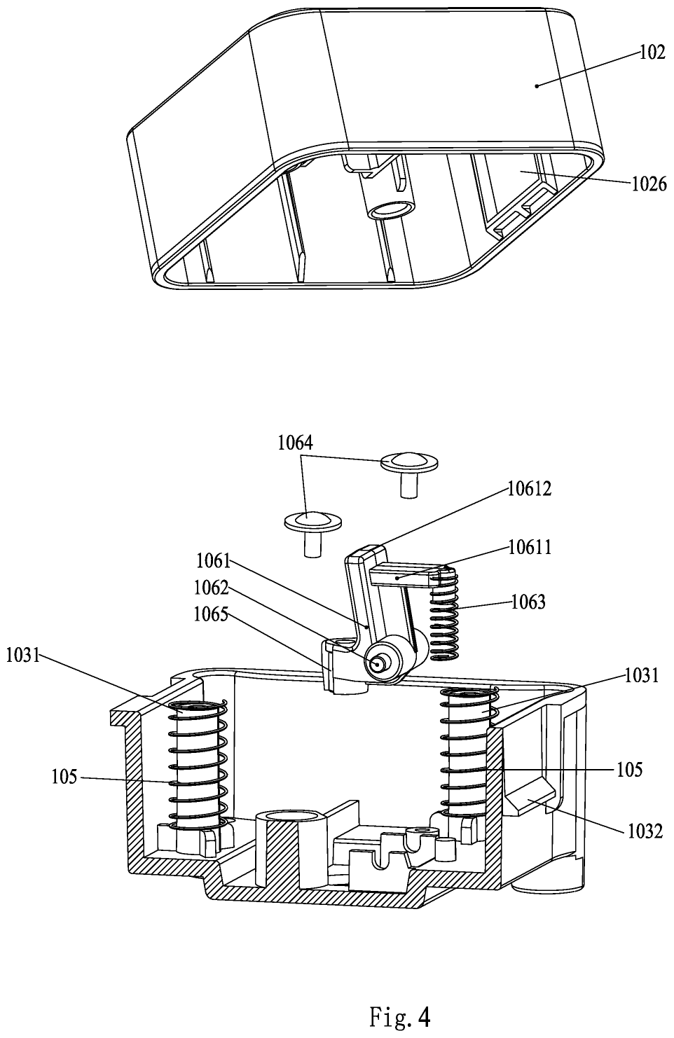

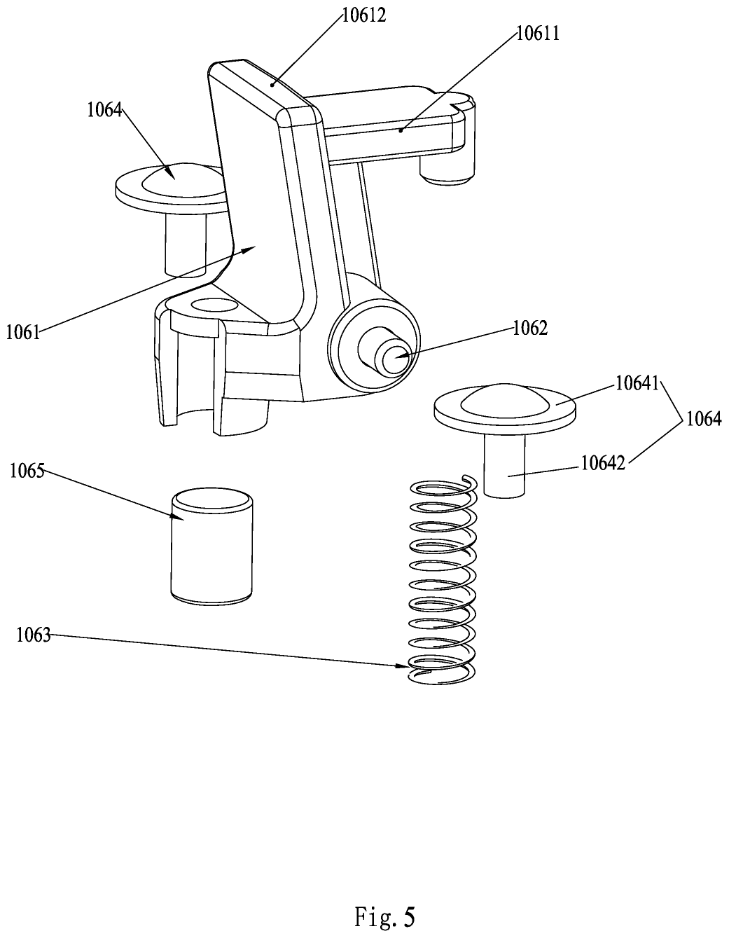

Reference is made to FIG. 4 to FIG. 7. the locking device includes a locking member 1061, a first magnet 1065, a second spring 1063, at least one position-limiting member 1064 and a first stopper 1023. The locking member 1061 is connected to the base 103 by a pivot 1062, and an upper part of the locking member 1061 further includes a transverse bar 10611, the first magnet 1065 is arranged at the bottom of the locking member 1061, one end of the second spring 1063 is against free end 10614 of the transverse bar 10611 of the locking member 1061, the other end of the second spring 1063 is against a convex point 1035 of the base 103, and the first magnet 1065 and the second spring 1063 are distributed on radial opposite sides of the pivot 1062. By changing the magnetic pole of the first magnet 1065, the first magnet 1065 can magnetically attract/repel the second magnet 303. The first stopper 1023 is arranged on the inner side of the top cover 102. Reference is made to FIG. 6, when the first magnet 1065 is magnetically attracted to the second magnet 303, and a torque direction of a magnetic force applied to the locking member 1061 is consistent with a torque direction of a preload of the second spring 1063 applied to the locking member 1061, in this case, the locking member 1061 is set in a locked state, and a top end 10612 of the locking member 1061 can contact with a bottom end of the first stopper 1023 of the top cover 102 to thereby restricting the top cover 102 from moving downward. Reference is made to FIG. 7, when the first magnet 1065 and the second magnet 303 are magnetically repulsive, the torque direction of the magnetic force applied to the locking member 1061 is opposite to the torque direction of the preload of the second spring 1063 applied to the locking member 1061, and the magnetic repulsion force applied to the locking member 1061 can overcome part of the preload (elastic restoring force) of the second spring 1063, and in this case, the locking member 1061 is set to an open state. The locking member 1061 moves around the pivot 1062 towards a direction away from the second magnet 303, and further the top end 10612 of the locking member 1061 is offset from the first stopper 1023, so that the top cover 102 can move downward. It is to be noted here that in the process that the locking member 1061 is switched from the open state to the locked state, the elastic restoring force generated by the second spring 1063 plays a role in boosting the locking member 1061 to the locked state. Reference is made to FIG. 4 and FIG. 5, the position-limiting member 1064 is arranged on the base 103 at a position near the pivot 1062, the position-limiting member 1064 is T-shaped, and includes a stopping part 10641 and a rod part 10642 from top to bottom. The rod part 10642 is arranged in the base 103 by penetrating the base 103 from top to bottom, and the stopping part 10641 is configured to restrict the pivot 1062 from moving upward to be away from the base 103, to further restrict the locking member 1061 from moving upward to be away from the base 103.

Specific working principle of the present application is as follows.

Reference is made to FIG. 6. When the locking member 1061 is in the locked state, the top cover 102 cannot move downward. Please refer to FIG. 7, when the locking member 1061 is in the open state, the top cover 102 is pressed downward to drive the ejector rod 101 to move downward synchronously. The ejector rod 101 passes through the first avoidance hole 201 and the second avoidance hole 3021 successively to implement the punching operation at one position of the paper. When the external force disappears, the top cover 102 receives a restoring force of the first spring 105 to move upward and be reset, and drive the ejector rod 101 to move upward and be reset synchronously. At this time, the punching position of the paper 5 can be changed. Since the pressing plate 2 is arranged between the base 103 and the bottom seat 3, the accuracy of paper punching can be effectively improved. Moreover, the base 103 and the pressing plate 2 are each attracted on the bottom seat 3. When the position of the base 103 changes, the position of the pressing plate 2 will not shift, so that the position of the paper will not shift, thus ensuring the accuracy of paper punching. The magnetic attracting units are arranged on the base 103, the pressing plate 2 and the bottom seat 3, so that the paper can be quickly clamped for being accurately punched, and the base 103, the pressing plate 2 and the bottom seat 3 can be easily and conveniently assembled and disassembled. Moreover, the cutter unit 1 is provided with the locking device, which can effectively improve the safety of the product to prevent misoperation.

Preferably, the cross sections of the top cover 102 and the base 103 are square, and four first avoidance holes 201 and four second avoidance holes 3021 are provided, and are configured to realize the drilling operation in one position when the top cover 102 and the base 103 rotate by 90°/time about their longitudinal centerline L synchronously and finally realize the drilling operation in four positions. At least the pressing plate 2 is provided with a number of sets of calibration holes 203. Each set of calibration holes 203 includes four calibration holes 203. The arrangement of each set of calibration holes 203 is consistent with the arrangement of the first avoidance holes 201. In this embodiment, the bottom seat 3 is also provided with a number of sets of calibration holes 301, and the arrangement of each set of calibration holes 301 is consistent with that of the second avoidance holes 3021.

Preferably, a top surface of the top cover 102 is provided with at least one building block bump 1024. By splicing the building block bump 1024 on the top cover 102 with other building block splicers, the overall beauty of the puncher can be further improved, and the playability and interest of the product can be greatly improved.

The work process is described in conjunction with the embodiments shown in FIGS. 1 to 10 as follows.

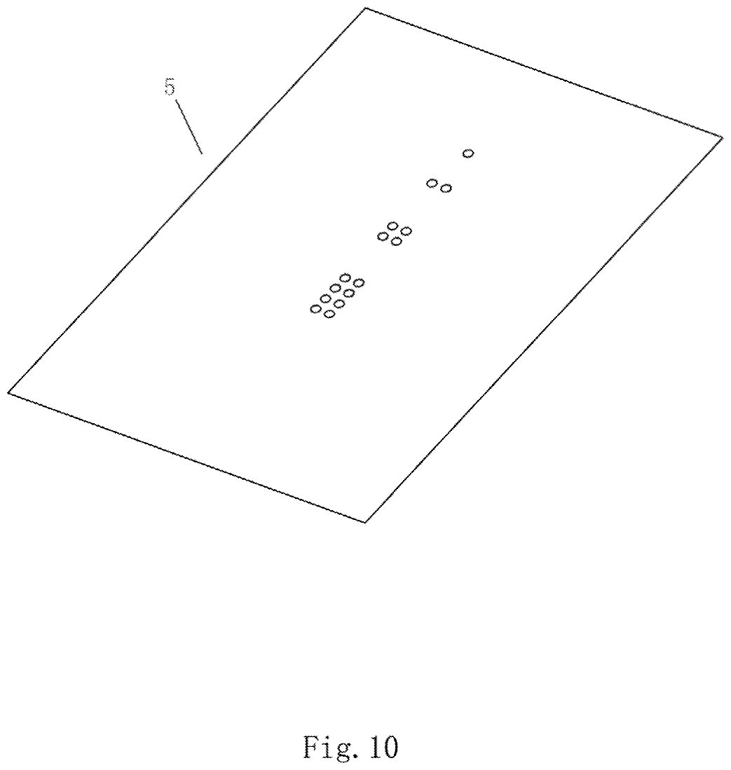

First, the paper 5 is placed on the bottom seat 3; then, the pressing plate 2 clamps the paper 5 on the bottom seat 3 through the second magnetic attracting units 4b, and then the cutter unit 1 is accurately positioned on the bottom seat 3 through the first magnetic attracting units 4a. At this time, due to the repulsive force between the first magnet 1065 and the second magnet 303, the locking member 1061 is converted to the open state, the ejector rod 101 is driven to move downward by pressing the top cover 102, and the ejector rod 101 is moved downward through a first avoidance hole 201 to punch the paper 5, thus, a hole is formed in the paper 5, and the waste material cut by punching is discharged through a second avoidance hole 3021 in the fixing plate 302 of the bottom seat 3. The cutter unit 1, after being turned by 90°, is repositioned on the bottom seat 3 through the magnetic attracting units. The top cover 102 is pressed to drive the ejector rod 101 to move up and down. The ejector rod 101 punches the paper 5 downward through the first avoidance hole 201, thus forming another hole in the paper 5. By analogy, the puncher can punch and cut multiple hole combinations in the paper 5, as shown in FIG. 10. The fixing plate 302 is removed and the sides of the second magnet 303 and the first magnet 1065 facing each other are set to have opposite magnetic poles, and then the fixing plate 302 is installed to the original position. The first magnet 303 and the second magnet 1065 magnetically attract each other. The locking member 1061 is in the locked state. The cutter unit 1 and the pressing plate 2 are successively attracted to the bottom seat 3, and the top cover 102 cannot be pressed downward.

The contents of the above embodiments are only the preferred embodiments of the present application, and the above preferred embodiments are not intended to limit the implementation scope of the present application. All equivalent changes made according to the scope of protection of the claims in this application are covered by the scope of protection of the claims in the present application.

1. A puncher capable of fast and accurate positioning, comprising a cutter unit, a pressing plate, and a bottom seat in the sequence from top to bottom, wherein the cutter unit comprises a ejector rod for drilling, a top cover, a base, and a number of first springs, the top cover is installed on the base to be movable up and down, one end of the ejector rod is fixed on an inner side of the top cover, another end of the ejector rod is a punching end facing towards the base, and moreover, the base is provided with a guide hole for the ejector rod to pass through; the first springs are arranged between the top cover and the base, and the first springs act on the top cover;
the pressing plate is arranged between the base and the bottom sea, and the pressing plate is provided with at least one first avoidance hole for the ejector rod to pass through;
the bottom sea is configured to bear an object to be punched, and is provided with at least one second avoidance hole for the ejector rod to pass through, the at least one second avoidance hole and the at least one first avoidance hole are arranged in one-to-one correspondence; and
the base is provided with a number of first magnetic attracting units, and the pressing plate is provided with a number of second magnetic attracting units, the bottom seat is provided with a number of third magnetic attracting units and a number of fourth magnetic attracting units, the third magnetic attracting units are magnetically attracted to the first magnetic attracting units to allow the base to be attracted on the bottom seat, and the fourth magnetic attracting units are magnetically attracted to the second magnetic attracting units to allow the pressing plate to be attracted on the bottom seat, for clamping the object to be punched between the pressing plate and the bottom seat.

2. The puncher according to claim 1, wherein the cutter unit further comprises a locking device, and the locking device comprises a locking member, a first magnet, a second spring and a first stopper; the locking member is connected to the base by a pivot, the first magnet is arranged at the locking member, the second spring acts on the locking member, and the first magnet and the second spring are distributed on radial opposite sides of the pivot respectively; the bottom seat is provided with a second magnet, a second magnet is arranged on the bottom seat, the second magnet and the first magnet are magnetically attractive/repulsive to each other;
the first stopper is arranged on the inner side of the top cover;
when the first magnet is magnetically attracted to the second magnet, and a torque direction of a magnetic force applied to the locking member is substantially consistent with a torque direction of a preload of the second spring applied to the locking member, in this case, the locking member is set in a locked state, and a top end of the locking member is capable of contacting with a bottom end of the first stopper to thereby restricting the top cover from moving downward;
and when the first magnet and the second magnet are magnetically repulsive, a torque direction of the magnetic force applied to the locking member is opposite to a torque direction of the preload of the second spring applied to the locking member, and the magnetic repulsion force applied to the locking member is capable of overcoming part of the preload of the second spring, and in this case, the locking member is set to an open state, the locking member moves around the pivot towards a direction away from the second magnet, and further the top end of the locking member is offset from the first stopper, so that the top cover is movable downward.

3. The puncher according to claim 2, wherein the locking device further comprises at least one position-limiting member, the position-limiting member is arranged on the base at a position near the pivot and is configured to restrict the locking member from moving upward.

4. The puncher according to claim 3, wherein the position-limiting member comprises a stopping part and a rod part from top to bottom, which is T-shaped; one end of the rod part is fixed on the base, and the stop portion is configured to restrict the pivot from moving upward, to further restrict the locking member from moving upward.

5. The puncher according to claim 2, wherein the support seat is provided with a detachable fixing plate, the fixing plate is configured to position the second magnet on the bottom seat, and the at least one second avoidance hole is provided in the fixing plate.

6. The puncher according to claim 1, wherein the top cover is provided with a second stopper extending downward from the inner side of the top cover, the second stopper has a slot in its inner cavity, one end of the ejector rod is disposed in the slot, and the end of the ejector rod is provided with a ring-shaped flange, the cutter unit further comprises a third spring, and the third spring is sleeved on the ejector rod, and two ends of the third spring are respectively against inner sides of the ring-shaped flange and the base, a preload applied to the ejector rod by the third spring allows the ring-shaped flange of the ejector rod to always abut against and contact with a bottom end of the second stopper, and further allows one end of the ejector rod to be fixed on the top cover.

7. The puncher according to claim 1, wherein the cutter unit is tetragonal shape and four corners at the bottom of the base are each provided with a downward extending protruding column, the protruding column is provided with a mounting hole, the first magnetic attracting unit is provided in each of the mounting holes; and the pressing plate is provided with avoidance parts at positions corresponding to the protruding columns.

8. The puncher according to claim 7, wherein the cutter unit is square shape, and four first avoidance holes and four second avoidance holes are provided and are configured to realize the drilling operation in one position when the cutter unit rotated 90 degree/times about its longitudinal centerline (L) and finally realize the drilling operation in four positions.

9. The puncher according to claim 8, wherein at least the pressing plate is provided with a number of sets of calibration holes, each set of calibration holes comprises four calibration holes, the arrangement of each set of calibration holes is consistent with the arrangement of the first avoidance holes.

10. The puncher according to claim 1, wherein the inner side of the top cover is provided with at least one position-limiting groove extending in a vertical direction, and an outer side of the base is provided with at least one engaging block corresponding in position to the at least one position-limiting groove.
